(19) United States
(12) Patent Application Publication
(10) Pub. No.: US 2025/0256572 A1
(43) Pub. Date: Aug. 14, 2025

(54) Method for Improving AR Representations of a 3D Head-up Display in a Motor Vehicle

(71) Applicant: Bayerische Motoren Werke Aktiengesellschaft, Muenchen (DE)

(72) Inventors: Guy BERG, Muenchen (DE); Maike GEBHART, Muenchen (DE); Michael Arthur JANZER, Unterschleissheim (DE); Sebastian Takeshi LAMPEN, Tokyo (JP); Lutz LORENZ, Deisenhofen (DE); Jochen PFANNSTIEL, Muenchen (DE)

(21) Appl. No.: 19/011,865

(22) Filed: Jan. 7, 2025

(30) Foreign Application Priority Data
Feb. 8, 2024 (DE) 10 2024 103 475.0

(51) Int. Cl. B60K 35/233; B60K 35/234; B60K 35/28; B60K 35/65

(52) U.S. Cl. CPC B60K 35/233; B60K 35/234; B60K 35/28; B60K 35/65; B60K 2360/177; B60K 2360/334; B60K 2360/731

(57) ABSTRACT

A method for operating a field-of-view display device in a motor vehicle is provided. The field-of-view display device includes a projection apparatus that generates a light beam bundle having desired display content and a partially transparent reflection pane arranged in the field of view of a passenger and is configured and is actuated to insert a virtual image into the field of view of the passenger via reflection of the light beam bundle from the reflection pane to their eyebox. The virtual image is positioned and oriented three-dimensionally so that it lies on a road surface lying in front, and the eyebox is adjustable for adaptation to different poses and sizes of the passenger. The display content during an eyebox adjustment for the time of flight is subjected to a modification which, in addition to mathematically exact tracking of the 3D position and orientation of the virtual image, which is contact-analogous (or oriented on real objects in front of the motor vehicle), includes a predetermined additional change of its position, scaling, stroke thickness, luminosity, and/or another display property, so that it always meets predetermined visibility and recognizability criteria.

### CROSS REFERENCE TO RELATED APPLICATION

This application claims priority under 35 U.S.C. § 119 from German Patent Application No. DE 10 2024 103 475.0, filed Feb. 8, 2024, the entire disclosure of which is herein expressly incorporated by reference.

### BACKGROUND AND SUMMARY

The invention relates to a method for operating a field-of-view display device in a motor vehicle, which is also known under the name head-up display (HUD). Such devices are used to generate a virtual image inserted into the field of view of a passenger via reflection on an at least partially transparent reflection pane, such as a windshield or rear window of the motor vehicle, or on a combiner pane provided separately for this purpose, which is arranged in the field of view of the passenger. The invention is also directed to a correspondingly configured control unit, a projection unit designed to output a suitable light beam bundle, a field-of-view display device containing these, and a motor vehicle equipped therewith.

Head-up displays (HUD) in motor vehicles generally have a virtual image plane standing nearly vertically, in which, for example, items of driver information such as a speed limit and current vehicle speed or warning and navigation messages are displayed as a virtual image, which is overlaid on the real surroundings, observed by the driver, in front of the motor vehicle. For this purpose, the HUD typically comprises a projection unit housed in the dashboard, which generates a light beam bundle having desired display content and projects it in suitable form and direction onto the windshield of the motor vehicle or onto a combiner pane arranged in front of it on the vehicle inside, from which it is reflected to the eyes of the driver.

The spatial position of the virtual image results here from the optical interplay of the reflection pane and the elements of the projection unit provided for beam generating, forming, and deflection, such as an image-generating display and a beam-deflecting and image-enlarging and/or image-correcting concave mirror.

Furthermore, 3D-HUD concepts are known for road vehicles in which the virtual image plane is not vertical, but rather nearly parallel to the road. A clear depth or 3D effect can thus be created for the observer. For this purpose, a virtual image is projected via the windshield into the depth in such a way that it extends approximately parallel to the roadway (from a close area at the lower image edge to a far area at the upper image edge, for example, at a distance from the eyes of the driver of approximately 2 m to 15 m).

As described in DE 11 2019 003 420 T5, for example, in this way a virtual image can be continuously displayed during a journey, which is perceived as adhering to the road surface by the driver. For this purpose, an image-generating display surface that absorbs projection light of a projector and displays a real image is arranged with a comparatively strong inclination in relation to the light axis of the projection light in the HUD interior. In order to keep the position of the virtual image display area constant in relation to the motor vehicle, this display surface can moreover be rotated and/or shifted in the event of a detected change of the pitch angle of the motor vehicle for adaptation to the changed motor vehicle orientation, so that the virtual image still matches with the road surface and does not lift off from it and thus irritate the passenger.

To save installation space, that spatial area (eyebox), from which the virtual image is perceptible, is generally limited to an eyebox size of, for example, approximately 50 mm. For small or large drivers having a correspondingly different eye height, the eyebox can be adjusted upward or downward via the adjustment of the concave mirror. The virtual image thus also appears higher or lower above the roadway. The adjustment of the eyebox can be performed manually by the driver or automatically via detection of their eye position by a suitable interior camera, as described, for example, in JP 2012-163613 A.

In this context, DE 10 2021 119 272 A1 discloses a field-of-view display device, in particular a head-up display, having a uniform alignment of the virtual image plane during the eyebox adjustment. For this purpose, the device comprises a mirror having a first adjustment device in the beam path of the light beam bundle, which is designed to be tilted for adaptation to different eyebox positions of different users, and a second adjustment device, which is designed for tilting of the imaging unit or a further optical component that retains the image alignment. The tilting retaining the image alignment is designed here so that the virtual image plane has a predetermined identical alignment in the different eyebox positions.

Furthermore, EP 3 933 488 A1 discloses an HUD system for a vehicle or for a machine. This HUD system is designed so that position and/or orientation of the virtual image and/or the eyebox are adaptable and/or rotatable, and changes in the alignment and orientation, distortions, and/or manipulations of the virtual image are enabled via a combiner. The virtual image can be moved both by software and mechanically. The system can be equipped with at least one eye tracking device, which is configured to measure the position and movement of the eyes for the eyebox adaptation.

It is the object of the present invention to specify an operating method which is alternative and/or improved with regard to the display options, the image quality, the installation space, and/or other aspects and a correspondingly designed projection unit for a field-of-view display device in a motor vehicle, which is designed to display virtual images located on the road surface.

This object is achieved by a method according to claim 1 for operating a field-of-view display device in a motor vehicle and by a corresponding control unit, projection unit, a field-of-view display device containing these, and a motor vehicle equipped therewith according to the other independent claims. Further embodiments are specified in the dependent claims. All refining features and effects mentioned in the claims and in the following description for the method also apply with respect to the control unit, the projection unit, the field-of-view display device, and the motor vehicle, and vice versa in each case.

According to a first aspect, a method for operating a field-of-view display device installed in a motor vehicle is provided. The field-of-view display device can be designed, for example, as a head-up display (HUD). The spatial orientation terms used herein such as “vertical”, “horizontal”, “forward”, “left”, “right”, “underneath”, “above”, etc. refer, if not indicated otherwise, to the typical vehicle-fixed Cartesian coordinate system having longitudinal, transverse, and vertical directions of the motor vehicle perpendicular to one another. The vehicle longitudinal direction is sometimes also referred to as the “direction of travel”.

The field-of-view display device comprises here a projection unit for generating a light beam bundle having desired display content and an at least partially transparent reflection pane arranged in the field of view of a passenger, so that the display content appears to this passenger via reflection on the reflection pane as a virtual image in a virtual display area located beyond the reflection pane. The field-of-view display device is designed here so that the virtual image is inserted into the field of view of the passenger via reflection of the light beam bundle from the reflection pane at an eyebox predetermined for their eyes. An eyebox is understood herein as usual as a two-dimensional or three-dimensional spatial area in the passenger compartment of the motor vehicle, from which the virtual image is visible in the intended quality.

The virtual image is positioned and oriented in this case analogously to contact in the three-dimensional space or oriented on real objects in front of the motor vehicle, in such a way that it appears to be located on a road surface lying in front of the motor vehicle. For adaptation to different poses and sizes of the passenger, a propagation direction of the light beam bundle and therefore the spatial position of the eyebox is adjustable, for example, by a suitable rotation of a concave mirror contained in the projection unit or another optical element in the beam path of the light beam bundle.

The display content to be generated by an image generator in the projection unit is subjected to a modification upon an eyebox adjustment for the time of flight which, in addition to mathematically exact tracking of the 3D position and orientation of the virtual image, comprises at least one predetermined additional change of its position, scaling, stroke thickness, luminosity, and/or another representation property, so that it always meets predetermined visibility and recognizability criteria for different sizes and poses of the passenger, for example, to ensure an essentially uniform visibility and recognizability of the virtual image for different sizes and poses of the passenger. The image generator is actuated, for example, by an associated control unit for this modification of the display content.

The mentioned visibility and recognizability criteria can be identical for all sizes and positions of the passenger. They can comprise, for example, an absolute and/or relative size of the virtual image or its individual partial objects and/or its/their geometric shape and/or distance from real objects within a display area that can be covered as a whole by the field-of-view display device (also called field of view, FOV).

One concept of the method presented herein thus consists of adapting the display contents (also called user interface, UI contents, or UI assets) in perspective depending on the location of the adjustable eyebox and therefore also of the virtual image so that they always appear “grid-parallel” to the road or surroundings in the meaning of augmented reality displays (also called AR or augmented reality). For this purpose, an adaptation of the representation perspective of the 3D display models is carried out in “real time” as a function of the spatial position (i.e., a three-dimensional position and orientation) of the eyebox. The eyebox location is adapted, for example, via the rotation of a concave mirror for the time-of-flight, in particular based on a detection of the eye positions of the relevant passenger by one or more suitable interior cameras in the vehicle.

In the case of mathematical exact tracking of the representation perspective to the eyebox adjustment, however, the problem can arise for small drivers, for example, that UI contents appear significantly smaller and/or more distorted and are therefore more poorly recognizable or more poorly readable than for an average driver, for whom the virtual image is optimized. This worsened recognizability/readability is compensated for in the present method by the mentioned additional change of the UI contents.

According to one embodiment, the mathematically exact tracking of the 3D position and orientation of the virtual image comprises an adaptation of its representation perspective in real time to a changed location of the eyebox so that the virtual image still has the same convergence with respect to the road surface and/or other real surrounding objects (in the meaning of AR displays). This can be implemented in particular by a perspective adaptation of the 3D position and orientation of the virtual image to an alignment of the road lying ahead changed by the eyebox adjustment and/or by an adaptation of the positioning of the virtual image within the three-dimensional virtual display area that can be covered as a whole by the field-of-view display device, so that it still remains displayed analogous to contact or correctly oriented to the same real objects in front of the motor vehicle.

The additional change can comprise multiple steps, which optionally build on one another and improve the display quality or visibility more and more.

According to one embodiment, the additional change comprises a one-dimensional area scaling of the three-dimensional virtual display area that can be covered as a whole by the field-of-view display device in the direction of travel (i.e., longitudinal direction) of the vehicle-fixed coordinate system. This area scaling can also be restricted to a partial area of the mentioned display area selected in a suitable manner, which comprises, for example, a particularly important partial object of the virtual image and its surroundings relevant for the contact-analogous display. The respective scaling origin of the area scaling is always here at the lower end of the overall virtual display area or its mentioned partial area.

According to a refining embodiment, the additional change additionally comprises a one-dimensional object scaling of at least one partial object of the virtual image in the mentioned direction of travel. The scaling origin is always at the lower end of the object or a mentioned partial object here. The area scaling is multiplied by the object scaling in the generation of the display content.

According to an alternative or additional refinement thereto, the additional change of a virtual image freely positionable as such, which was shifted as a result of the mentioned tracking and/or scaling within the display area that can be covered as a whole by the field-of-view display device, furthermore comprises a vertical and/or horizontal position compensation, so that the virtual image is displayed in a constant position in a predetermined relation to a border (for example, an upper or lower edge) of the display area that can be covered as a whole by the field-of-view display device.

In a further alternative or additional refinement, the additional change furthermore comprises a predetermined contouring and/or contrast amplification and/or increase of the stroke thickness and/or increase of the luminosity (luminance amplification) and/or adaptation of the color tone value of the virtual image. This can also contribute to meeting the mentioned predetermined visibility and recognizability criteria.

According to a further aspect, a control unit is provided, which is designed and configured to carry out the method presented herein automatically. For this purpose, for example, a corresponding computer program (software) can be loaded in a processor of the control unit and can run during operation of the field-of-view display device.

According to a further aspect, the mentioned projection unit is provided, which can be surrounded, for example, by a protective housing having a cover pane transparent to the light beam bundle. The projection unit is designed and configured for injecting a virtual image, which extends on a road surface lying in front of the motor vehicle, into the field of view of a passenger via reflection on a partially transparent reflection pane (which is located outside the projection unit and is not the component thereof) arranged in their field of view. For this purpose, the projection unit comprises an image generator designed for generating a light beam bundle having desired display content. In principle, any imaging technology is suitable for the image generator. In particular, it can be designed as a light-transmitting or light-emitting flat display screen, for example, a liquid crystal display screen (LCD) or a μLED or OLED display, but alternatively also as a projector-based image generator or a waveguide-based display.

If needed, the projection unit can have further mechanical and optical elements (e.g., a concave mirror, etc.) in the beam path of the light beam bundle generated by the image generator, in order to achieve in addition desired image properties. The projection unit also comprises an adjustment device, which is designed for the mentioned adjustment of an eyebox predetermined for the eyes of the passenger for adaptation to different passenger poses and sizes, and the above control unit. The control unit can be integrated into the projection unit. However, it can also be located at another point in the motor vehicle, for example, implemented in its central control unit, and communicate with the projection unit via wired or wireless connections to carry out the above method.

According to a further aspect, a field-of-view display device for a motor vehicle is provided, which comprises the above projection unit and an at least partially transparent reflection pane arranged in the beam path of the light beam bundle emitted thereby. The reflection pane here is arranged/to be arranged in the field of view of a passenger and is designed so that it reflects the light beam bundle to an eyebox predetermined for their eyes, due to which the display content is displayable to said passenger as a virtual image beyond the reflection pane.

According to a further aspect, the above motor vehicle is provided having longitudinal, transverse, and vertical directions perpendicular to one another of a vehicle-fixed Cartesian coordinate system. The motor vehicle comprises a vehicle window, which at least partially delimits a passenger compartment, for example, a windshield. Furthermore, the field-of-view display device presented above is provided in the motor vehicle, the projection unit of which is arranged in the passenger compartment, in particular in the interior of a dashboard arranged below the windshield and the reflection pane of which is designed as a section of the vehicle window or as a combiner pane arranged in the passenger compartment. During operation of the field-of-view display device, a virtual image is projected, for example, via the windshield into the depth in such a way that it extends approximately parallel to the roadway (from a close area at the lower image edge to a far area at the upper image edge, for example, at a distance from the eyes of the driver or front passenger of approximately 2 m to 15 m).

The above aspects of the invention and the embodiments thereof and specific designs are explained in more detail hereinafter on the basis of examples illustrated in the appended drawings. The drawings are schematic and therefore are not to be understood as being strictly to scale. In the figures:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a longitudinal sectional illustration of a motor vehicle having a field-of-view display device according to an exemplary embodiment of the invention;

FIGS. 2a-2b show two different perspective views for illustrating an exemplary modification of a virtual marking of a vehicle traveling ahead after an eyebox adjustment in the field-of-view display device of FIG. 1; and

FIG. 3 shows an example of a modification of a virtual turning arrow after an eyebox adjustment in the field-of-view display device of FIG. 1, from the viewpoint of the driver.

### DETAILED DESCRIPTION OF THE DRAWINGS

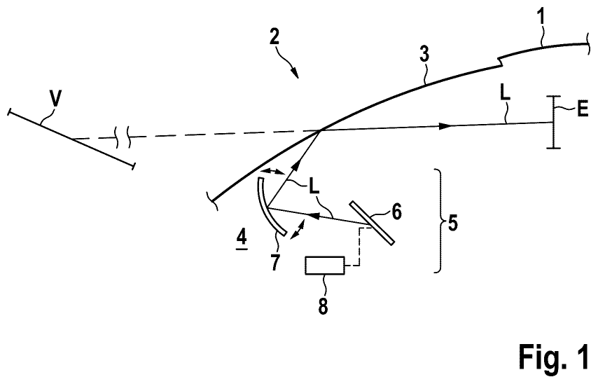

All various embodiments, variants, and specific design features, which are mentioned further above in the description and in the following claims, of the method, the control unit, the projection unit, the field-of-view display device, and the motor vehicle according to the above aspects of the invention can be implemented in the examples shown in FIGS. 1 to 3, in particular also alternatively or additionally to the features shown therein. They are therefore not all repeated once again hereinafter. The same applies accordingly to the term definitions already indicated further above and effects with respect to individual features which are shown in FIGS. 1-3.

FIG. 1 shows a very simplified schematic vertical longitudinal sectional illustration of an exemplary embodiment of a motor vehicle 1 having a field-of-view display device 2 presented herein, which is designed to generate a virtual image V in the field of view of a passenger in a virtual image plane in front of the motor vehicle 1. The motor vehicle 1 is only indicated in FIG. 1 by its windshield 3, which is used as a reflection pane of the field-of-view display device 2. Underneath this, a projection unit 5 of the field-of-view display device 2 is arranged in a dashboard 4 (not shown in more detail). Solely by way of example, it is a head-up display (HUD).

The projection unit 5 contains an image generator designed to generate a desired display content, in this example a display 6 (e.g., an LCD). A light beam bundle L originating from its display surface, which transports the display content to an eyebox E of the passenger (e.g., driver, not shown separately) in the motor vehicle 1, is indicated in simplified form by its center beam, which leads approximately from a center of the display surface into a center of the eyebox E.

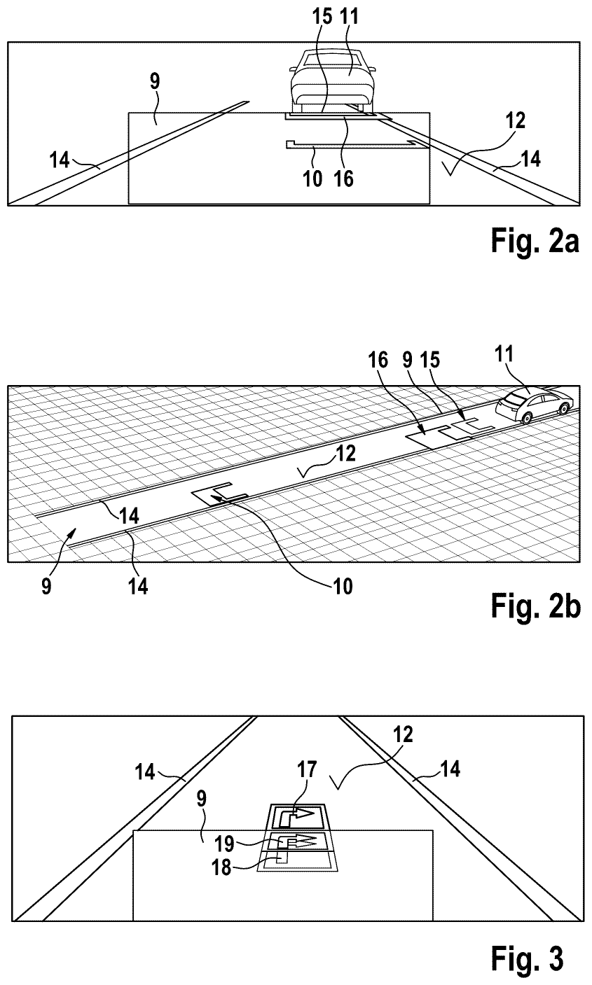

In the further beam path of the light beam bundle L, a concave mirror 7 is arranged and designed in such a way that the light beam bundle L leaves the projection unit 5 in a suitable shape and direction in order to then be reflected by the at least partially transparent reflection pane (windshield 3 here) to the eyebox E and to thus display the image content to the driver as a virtual image V. The virtual image V is positioned and oriented here in three-dimensional space in such a way that it appears to be located on a road surface lying in front of the motor vehicle 1 (cf. FIGS. 2a-3).

The display 6, i.e., its image-generating display surface, is arranged here in this example at a suitable tilt angle with respect to the mentioned center beam, so that the virtual image V is generated in a nearly recumbent virtual image plane (e.g., at a distance from the eyebox E of approximately 2 m at the lower image edge to approximately 15 m at the upper image edge). A depth effect is thus assisted in its three-dimensional orientation along the road surface lying ahead.

As indicated by rotation arrows, the concave mirror 7 is rotatable in order to adjust the spatial location of the eyebox E for adaptation to different poses and sizes of the driver. The display content to be generated by the display 6 is subjected during an eyebox adjustment to a modification in real time, which is illustrated on the basis of several specific examples in FIGS. 2a-3. For this purpose, the method presented herein is carried out in a control unit 8, which actuates the display 6 to generate the respective display content, said method comprising the following steps in this example:

A fundamental requirement for this modification is an adaptation of the display perspective in “real time” as a function of the location of the eyebox E (and thus also of the virtual image V), so that it has the same convergence in relation to the road or surroundings in terms of augmented reality displays. This adaptation of the display perspective is designated further above as mathematically exact tracking of the 3D position which is analogous to contact (or oriented to real objects in front of the motor vehicle) and orientation of the virtual image V during an eyebox adjustment and can comprise the following in particular:
A perspective adaptation of the alignment, which is defined, for example, by an angle of inclination of a roadway marking or roadway border. This adaptation can be imagined visually as a rotation of a virtual camera around a vehicle transverse axis.
Repositioning the UI contents within the FOV, in order to continue to reference to the same real object, such as a vehicle driving ahead.

However, the problem arises in particular for small drivers that UI contents appear significantly smaller and distorted and are therefore more poorly recognizable or more poorly readable. This worsened recognizability/readability is compensated for in the present method by a single-step or multistep additional change of the UI contents, which is illustrated in FIGS. 2a to 3 on the basis of two examples and is described hereinafter.

This additional change serves for improved, in particular more plausible and robust, perceptibility/recognizability/readability of the virtual image V or its individual partial images or UI contents and correlates with the correspondingly set eyebox position. This method of dynamic modification additionally receives the appearance in the correct perspective of the UI elements over all eyebox changes.

The additional change initially contains a scaling in 3D space in this example, comprising:
a one-dimensional scaling of the virtual 3D world to be displayed (also called area scaling) in the direction of travel; for this purpose, the scaling origin of the world scaling always has to be defined at the lower end of the FOV. The UI contents located in the 3D world are influenced by this world scaling, which results in a shape change and, under certain circumstances, a position change of the UI contents.
an object-specific one-dimensional scaling (also called object scaling) from the UI element origin, likewise in the direction of travel of the vehicle-fixed coordinate system.
the multiplication of these two scaling factors results in the final UI object size.

To illustrate these steps, FIG. 2a shows a perspective view from the viewpoint of the driver of a display area 9 (also called field of view, FOV) that can be covered as a whole by the field-of-view display device 2 of FIG. 1, having a virtual marking 10 of a vehicle 11 driving ahead. The virtual marking 10 is represented as contact analogous to the vehicle 11 traveling ahead and to a road surface 12 lying ahead of the ego motor vehicle 1 as lying on the road surface. The perspective course of the road can be seen in FIG. 2a by lane or roadway borders 14.

The size and location of the virtual marking 10 after the above adaptation of the representation perspective results in this case by mathematically exact tracking of this UI element for an eyebox position for an average person. The same UI asset results after mathematically exact tracking in the case of an eyebox location for a small driver having a correspondingly smaller look down angle in a virtual marking 15 displayed in the correct perspective. As becomes clear from FIG. 2a, however, this display is readable/recognizable in a clearly worse manner for the small driver, because it stays too close to the vehicle 11 driving ahead and also appears too narrowly here in the vertical direction. Instead, a modified UI asset in the form of a virtual marking 16 is therefore displayed to the small driver as a result of the above additional change (scaling), which has a greater distance from the vehicle 11 driving ahead and a greater width in the direction of travel, due to which it is recognizable and readable just as well in the eyebox location for a small driver as the virtual marking 10 for a driver of an average body size from their eyebox E.

FIG. 2b shows the same thing as FIG. 2a to illustrate this additional change once again from another perspective, wherein reference is made with respect to content to the above description of FIG. 2a.

An expanded additional change includes repositioning in the 3D space: Upon a translation from freely positionable UI contents in the FOV, a vertical/horizontal position compensation can become necessary in order to display the UI element in a constant position in relation to the FOV borders (e.g., upper image edge, cf. FIG. 3). In this case, the distance in the viewing direction of the UI element (object origin) to the vehicle-fixed coordinate origin (lower edge of the FOV) is related to the eyebox position (inclination, look down angle). The result is offset with the UI element position in the vehicle-fixed coordinate system and results in repositioning.

For explanation, FIG. 3 shows, in a perspective view from the viewpoint of the driver, a display area 9 that can be covered as a whole by the field-of-view display device 2 of FIG. 1, having a virtually inserted turning arrow 17. This is represented analogous to contact to a road surface 12 lying in front of the ego motor vehicle 1 as lying on the road surface. The perspective course of the road can be seen, similarly as in FIGS. 2a-2b, by lane or roadway borders 14.

The size and location of the virtual turning arrow 17 after the above adaptation of the display perspective results here by way of mathematically exact tracking of this UI element for an eyebox position for an average person. The same UI asset results after mathematically exact tracking in the case of an eyebox location for a large driver having a correspondingly larger look down angle in a virtual turning arrow 18 displayed in the correct perspective. As becomes clear from FIG. 3, the proportion of this UI element in relation to the overall display is excessively large; in other words, the virtual turning arrow 18 displayed in the correct perspective occupies approximately half the height of the entire display area 9 that can be covered by the field-of-view display device 2. Instead, a modified UI asset in the form of a virtual turning arrow 19 is therefore displayed to the large driver as a result of the additional change explained above, which has a correct proportion ratio of the UI element to the overall display, similar to that for a driver of an average body size.

In optional further additional change steps, the appearance of object-inherent properties of individual UI assets of the virtual image V can also be modified for the above-mentioned purposes, for example by:
an increase of the stroke thickness (contouring); and/or
a contrast amplification; and/or
an increase of the luminosity (luminance amplification); and/or
an adaptation of the color tone value.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 motor vehicle
2 field-of-view display device
3 windshield
4 dashboard
5 projection unit
6 display
7 concave mirror
8 control unit
9 display area that can be covered, also called FOV
10 virtual marking for an average person
11 vehicle driving ahead
12 road surface lying ahead
14 lane or roadway borders
15 a marking in the correct perspective for a small driver
16 an additionally modified marking for the small driver
17 virtual turning arrow for an average person
18 a turning arrow in the correct perspective for a large driver
19 an additionally modified turning arrow for the large driver
L light beam bundle
E eyebox
V virtual image

What is claimed is:

1. A method for operating a field-of-view display device in a motor vehicle, the method comprising:
generating, by a projection unit of the field-of-view display device, a light beam bundle having desired display content and a partially transparent reflection pane arranged in a field of view of a passenger;
inserting a virtual image into the field of view of the passenger via reflection of the light beam bundle from the reflection pane to an eyebox predetermined for the passenger, wherein the virtual image is positioned in a contact-analogous manner in a three-dimensional space or oriented on real objects in front of the motor vehicle, so that the virtual image appears to be lying on a road surface in front of the motor vehicle;
adapting a propagation direction of the light beam bundle and the eyebox to different poses and sizes of the passenger; and
modifying the display content during an eyebox adjustment for a time of flight, in addition to mathematically exact tracking of a 3D position and orientation of the virtual image, which is contact-analogous or oriented on real objects in front of the motor vehicle, including at least one predetermined additional change of position, scaling, stroke thickness, luminosity, and/or another display property of the display content, so that the display content always meets predetermined visibility and recognizability criteria.

2. The method according to claim 1, wherein
the mathematically exact tracking of the 3D position and orientation of the virtual image, which is contact-analogous or oriented to real objects in front of the motor vehicle, comprises an adaptation of its display perspective for the time of flight to a changed location of the eyebox, so that the virtual image still has the same convergence in relation to the road surface and/or to other real surrounding objects, the adaptation including:
a perspective adaptation of the 3D position and orientation of the virtual image to an alignment of the road lying ahead which is changed by the eyebox adjustment; and/or a positioning adaptation of the virtual image within a three-dimensional virtual display area that is coverable as a whole by the field-of-view display device, so that the virtual image remains displayed in a contact-analogous manner or correctly oriented to the real objects in front of the motor vehicle.

3. The method according to claim 1, wherein
the additional change comprises a one-dimensional area scaling of at least a partial area of the three-dimensional virtual display area that is coverable as a whole by the field-of-view display device in the direction of travel of a vehicle-fixed coordinate system; and
a respective scaling origin of the one-dimensional area scaling always lies at a lower end of the three-dimensional virtual display area or the partial area.

4. The method according to claim 2, wherein
the additional change comprises a one-dimensional area scaling of at least a partial area of the three-dimensional virtual display area that is coverable as a whole by the field-of-view display device in the direction of travel of a vehicle-fixed coordinate system; and
a respective scaling origin of the one-dimensional area scaling always lies at a lower end of the three-dimensional virtual display area or the partial area.

5. The method according to claim 3, wherein
the additional change comprises, in addition to the area scaling, a one-dimensional object scaling of at least a partial object of the virtual image in the direction of travel;
the scaling origin of the object scaling always lies at the lower end of the object or the partial object; and
the area scaling is multiplied with the object scaling.

6. The method according to claim 3, wherein
the additional change of a virtual image which is freely positionable and was shifted as a result of the tracking and/or scaling within the display area that is coverable as a whole by the field-of-view display device additionally comprises a vertical and/or horizontal position compensation, in order to display the virtual image in a constant position in a predetermined relation to a border of the display area.

7. The method according to claim 4, wherein
the additional change of a virtual image which is freely positionable and was shifted as a result of the tracking and/or scaling within the display area that is coverable as a whole by the field-of-view display device additionally comprises a vertical and/or horizontal position compensation, in order to display the virtual image in a constant position in a predetermined relation to a border of the display area.

8. The method according to claim 3, wherein
the additional change additionally comprises a predetermined contouring and/or contrast amplification and/or increase of the stroke thickness and/or increase of the luminosity and/or adaptation of the color tone value of the virtual image.

9. The method according to claim 4, wherein
the additional change additionally comprises a predetermined contouring and/or contrast amplification and/or increase of the stroke thickness and/or increase of the luminosity and/or adaptation of the color tone value of the virtual image.

10. The method according to claim 5, wherein
the additional change additionally comprises a predetermined contouring and/or contrast amplification and/or increase of the stroke thickness and/or increase of the luminosity and/or adaptation of the color tone value of the virtual image.

11. A control unit designed and configured for an automatic execution of a method according to claim 1.

12. A projection apparatus for a field-of-view display device for a motor vehicle, which is designed and configured for inserting a virtual image, which extends on a road surface lying in front of the motor vehicle, into the field of view of a passenger via reflection on a partially transparent reflection pane arranged in their field of view, the projection apparatus comprising:
an image generator configured to generate a light beam bundle having a desired display content;
an adjustment device configured to adjust an eyebox predetermined for eyes of the passenger for adaptation to different poses and sizes of the passenger; and
a control unit configured to actuate the image generator in order to carry out a method according to claim 1.

13. A field-of-view display device for a motor vehicle, comprising:
a projection apparatus according to claim 12; and
an at least partially transparent reflection pane arranged in a beam path of the light beam bundle output by the projection apparatus, which is arranged in the field of view of the passenger and is configured to reflect the light beam bundle to the eyebox (E), so that the display content is displayed to the passenger as a virtual image beyond the reflection pane.

14. A motor vehicle having longitudinal, transverse, and vertical directions of a vehicle-fixed Cartesian coordinate system which are perpendicular to one another, comprising:
a vehicle windshield which at least partially delimits a passenger compartment; and
a field-of-view display device according to claim 13, the projection apparatus of which is arranged in the passenger compartment, in an interior of a dashboard arranged below the vehicle windshield, and the reflection pane of which is designed as a section of the vehicle windshield or as a combiner pane arranged inside the vehicle inside in a front portion thereof.
